(19) United States
(12) Patent Application Publication
(10) Pub. No.: US 2015/0234409 A1
(43) Pub. Date: Aug. 20, 2015

(54) SYSTEM FOR ANALYZING OPPORTUNITIES FOR POWER DEMAND CONTROL

(71) Applicant: Powerit Solutions, LLC, Seattle, WA (US)

(72) Inventors: James Griner, Woodinville, WA (US); Vaclav Mydlil, Issaquah, WA (US)

(73) Assignee: POWERIT SOLUTIONS, LLC, Seattle, WA (US)

(21) Appl. No.: 14/624,385

(22) Filed: Feb. 17, 2015

Related U.S. Application Data
(60) Provisional application No. 61/941,362, filed on Feb. 18, 2014.

(51) Int. Cl. G05F 1/66; G05B 15/02

(52) U.S. Cl. CPC G05F 1/66; G05B 15/02

(57) ABSTRACT

Power demand information (e.g., a power demand profile) is obtained for a time period (e.g., a billing period) having a plurality of intervals. The power demand information represents power demand for the time period. The power demand information can be a historical power demand profile, in which historical power demand is represented for a past time period. Power demand can include one or more power loads. A target demand limit can be used to modify power demand profiles. The modified demand profiles can allow users to, for example, determine how an automated power control system can benefit them and visualize how the power demand patterns of their facilities can be adjusted to realize such benefits.

### CROSS-REFERENCE TO RELATED APPLICATION

This application claims the benefit of U.S. Provisional Patent Application No. 61/941,362, filed on Feb. 18, 2014, the disclosure of which is hereby incorporated by reference in its entirety.

### BACKGROUND

Facilities that have high power and energy requirements (e.g., for manufacturing processes) can benefit from automated power control systems that reduce power demand in order to control costs. However, such automated power control systems may have significant investment costs associated with them, and the actual benefits of such systems may not be immediately clear.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computer system obtains power demand information for a time period (e.g., a billing period) comprising a plurality of intervals. The computer system selects at least two of the intervals (e.g., at least two consecutive intervals). Each of the selected intervals has a power demand value. The computer system calculates a target demand limit for the selected intervals based at least in part on the power demand values, and applies the target demand limit to the power demand information to obtain a modified power demand profile.

Power demand information (which may include a historical power demand profile) represents power demand for the time period, and the power demand includes one or more power loads. A target demand limit can facilitate controlling power loads for selected intervals, which may involve reducing and/or maintaining power loads.

Applying a target demand limit to power demand information may include comparing the target demand limit with power demand values of selected intervals, and/or shifting power demand associated with a selected interval to another selected interval. If an overage is identified in a selected interval, the overage can be shifted to another selected interval. Calculating the target demand limit may include calculating an average of the power demand values of the selected intervals.

Selected intervals may have a time-of-use parameter, such as on-peak, off-peak, or part-peak. Power demand values of selected intervals may include a peak power demand value for the time period.

In another aspect, a computer system obtains power demand information for a time period comprising a plurality of intervals and selects at least two of the intervals. Each of the selected intervals has an initial power demand value. In this aspect, the selected intervals include a peak power demand interval, and the initial power demand value of the peak power demand interval is a peak power demand value. The computer system calculates a target demand limit for the selected intervals based at least in part on the initial power demand values. The target demand limit is less than the peak power demand value. The computer system applies the target demand limit to the power demand information to obtain a modified power demand profile in which at least the peak power demand value is reduced. The target demand limit may facilitate controlling power loads for the selected intervals, which may involve reducing at least one of the power loads for the peak power demand interval.

In another aspect, a computer system obtains power demand information for a time period comprising a plurality of intervals and obtains load constraint information for one or more power loads. The computer system selects at least two of the intervals, each having a power demand value. The computer system calculates a target demand limit for the selected intervals based at least in part on the power demand values and the load constraint information. The computer system applies the target demand limit to the power demand information to obtain a modified power demand profile. The load constraint information may include a minimum load value and/or an indication that at least one of the power loads can be reduced to meet the target demand limit.

In another aspect, a computer system obtains power demand information and a target demand limit for a time period comprising a plurality of intervals, and selects one or more of the intervals over which power loads can be reduced, based at least in part on the target demand limit. The target demand limit may be selected by a user or calculated automatically by the computer system, e.g., as an average of power demand values of the selected intervals. The power loads may include a constrained power load.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1-4 are flow charts depicting illustrative methods according to various aspects of the present disclosure;

FIG. 5 is a bar graph illustrating a power demand profile for a billing period;

FIG. 6 is a bar graph illustrating a modified power demand profile for the billing period shown in FIG. 5;

FIG. 7 is a bar graph illustrating a modified power demand profile for the billing period shown in FIG. 5 in view of constraints on loads;

FIG. 8A is a flow chart of an illustrative process that can be used to determine a target demand limit;

FIG. 8B is a flow chart of an illustrative process that can be used to determine a target demand limit in which multiple times-of-use (TOUs) may be in effect;

FIGS. 9A-9J are screenshot diagrams depicting features of an illustrative user interface of a system for analyzing opportunities for power demand control;

FIG. 10 is a block diagram that illustrates aspects of an exemplary computing device appropriate for use in accordance with embodiments of the present disclosure.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

Facilities that have high power and energy requirements (e.g., for manufacturing processes) can benefit from automated power control systems that reduce power demand in order to control costs. However, such automated power control systems may have significant investment costs associated with them, and the actual benefits of such systems may not be immediately clear.

For example, many utilities have a component of their billing that depends on the maximum usage for any debit period interval in a billing period. A customer may have some idea that cost savings could be realized if the maximum usage could be reduced, but they may not have any way to learn what the cost savings could be, or what realistic adjustments they might be able to make in terms of power usage.

According to embodiments described herein, systems and methods for analyzing opportunities for demand control allow users to determine how such automated systems can benefit them. For example, a user can learn that by shifting some usage from the peaks in the usage profile into lower usage intervals, the overall usage can remain the same (which may translate into no loss in productivity), but the peak demand, and therefore the cost to the user, can be reduced.

According to embodiments described herein, it is possible to analyze the potential impacts of such automated power control systems, both in terms of cost reduction as well as reduction of power loads, before committing to the costs of installing such a system. Energy usage data (e.g., in the form of demand profiles that show usage over time) can be analyzed, and the results of the analysis can provide users with information that describes the impacts of such systems in terms of a modified demand profile and/or cost savings.

As described herein, a target demand limit can be calculated by a demand control analysis system. The target demand limit can represent a goal for limiting peak power usage levels over a particular time period. The target demand limit may include power usage associated with one or more power loads. The particular number of power loads and the nature of the power loads can vary depending on the facility being analyzed.

The target demand limit can be applied to a limited number of time intervals within a time period (e.g., a billing period) over which the demand (usage over time, e.g., kWh/h) from one or more loads may be reduced. The target demand limit can provide a power threshold that is optimized for cost savings in view of a utility's peak demand charge. The target demand limit also can be adjusted to account for loads that are constrained in some way (e.g., in view of a minimum load level specified by a user).

In at least one embodiment, loads can be controlled within a number of consecutive debit period intervals over which the demand from the loads may be allowed to be reduced. The demand control analysis system can analyze historical demand profiles and determine a minimum target demand limit that will only impact the loads for the specified number of intervals. Or, the demand control analysis system can calculate a number of consecutive debit period intervals over which loads may be reduced given a specified target demand limit. Given a power threshold (either calculated or specified by the user), the system can calculate the impact on a historical power profile for the process being analyzed. The demand control analysis system can allow users to specify the maximum load that can be reduced during any debit period interval. This allows users to restrict the analysis to a subset of the loads that contribute to the overall power profile of their facility.

Data that can be analyzed by the demand control analysis system includes total usage and billing time-of-use. For example, the system can analyze total usage (in kWh) for each debit period interval for a billing period being analyzed. The system also can analyze billing time-of-use (e.g., off-peak, part-peak, on-peak, etc.) associated with each interval.

In some embodiments, the analysis involves looking at actual usage over a set of intervals (e.g., consecutive debit period intervals) and calculating a new target demand limit. Reaching the target usage level for a set of intervals may require curtailing some power usage in some intervals. A user can specify how long their process can be affected (e.g., as a number of intervals) by having the overall usage curtailed.

The target demand limit can allow some power usage levels to be reduced without affecting the overall productivity of a facility, if some usage can be shifted from intervals with higher values to intervals with lower values. The target usage level can represent a maximum potential usage for the set of intervals.

A user also can specify a target demand limit and analyze the potential impacts of their own chosen limit. For example, according to at least one described embodiment, the user can specify an upper usage limit and the demand control analysis system can analyze historical data to determine how many consecutive debit period intervals would be impacted by limiting the overall usage to that limit.

If a user knows they have a subset of loads in their facility that they can control, they can limit the analysis to only reduce the usage by the amount of energy that those loads use. A user can specify constraints for some or all loads. For example, if the user can easily turn off the lights in a building but they never want to turn off the heat, they can limit the analysis to only reduce the overall usage by the amount consumed by the lights. A constraint can be placed on the heating load, to avoid reducing the heating load below a particular specified level. The user is allowed to take into account specifics of their process so that an unreasonable target demand limit is not returned. In the example described above, turning off the heat while some other process is consuming energy may potentially level out peaks in the usage profile but would be unacceptable to the user if the user has already specified that the heat should not be turned off.

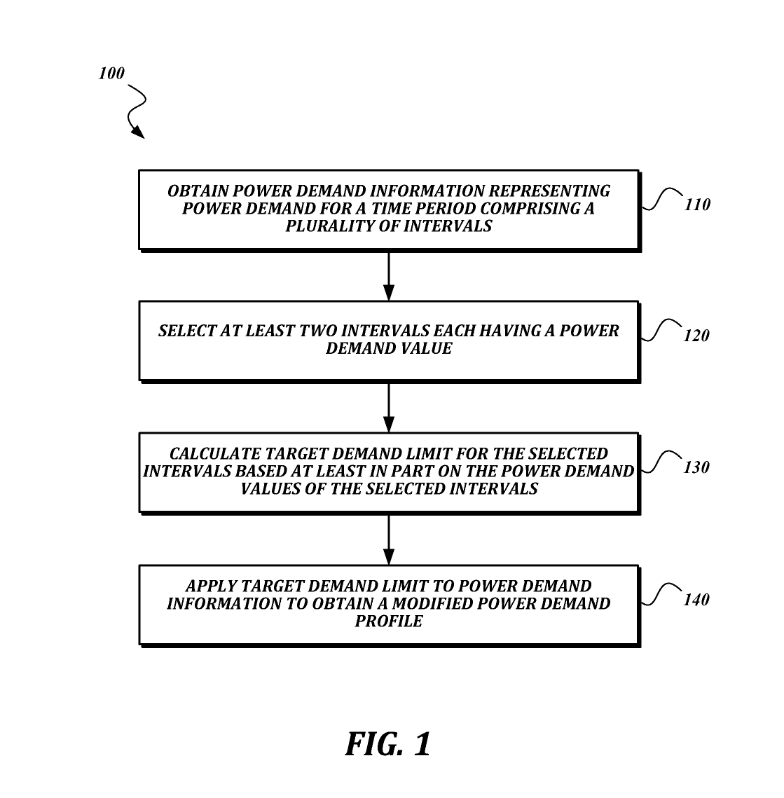

In illustrative methods described with reference to FIGS. 1-4, power demand information (e.g., a power demand profile) is obtained for a time period (e.g., a billing period) comprising a plurality of intervals. The power demand information represents power demand for the time period. The power demand information can be a historical power demand profile in which historical power demand is represented for a past time period. Power demand can include one or more power loads.

A target demand limit can be used to modify power demand profiles. The modified demand profiles can allow users to, for example, determine how an automated power control system can benefit them and visualize how the power demand patterns of their facilities can be adjusted to realize such benefits. The target demand limit can be set such that the overall power usage within selected intervals remains the same, while allowing for a reduction of peak demand. The target demand limit can be calculated as an average of power demand values of selected intervals.

The target demand limit can facilitate controlling the power loads for selected intervals, such as by reducing at least one of the power loads for at least one of the selected intervals (e.g., a peak power demand interval), or by maintaining one or more power loads and reducing one or more other power loads.

In the example shown in FIG. 1, power demand information is obtained at step 110, and at least two intervals are selected (e.g., by a user or automatically) at step 120. In the example shown in FIG. 1, each of the selected intervals has a power demand value. At step 130, a target demand limit is calculated (e.g., as an average of the power demand values of the respective selected intervals) for the selected intervals based at least in part on the power demand values of the selected intervals. At step 140, the target demand limit is applied to the power demand information to obtain a modified power demand profile.

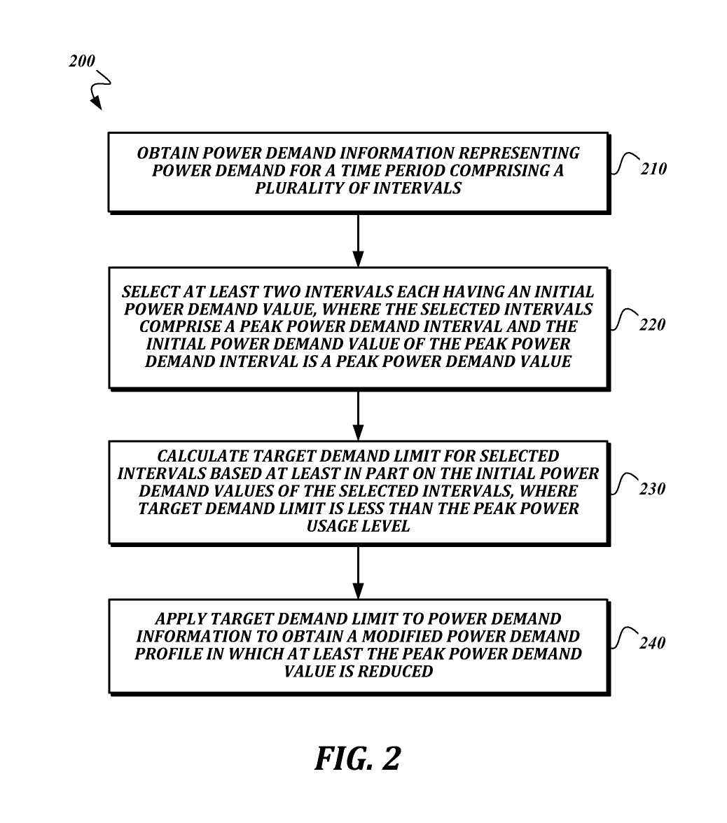

In some embodiments, the power demand values of selected intervals may include a peak power demand value for the time period. In such cases, the target demand limit may be less than the peak power demand value. Reducing the peak power demand value to the target demand limit can provide benefits in terms of, for example, reduced peak demand charges. In the example shown in FIG. 2, power demand information is obtained at step 210, and at least two intervals are selected (e.g., by a user or automatically) at step 220. The selected intervals include a peak power demand interval. Each of the selected intervals has an initial power demand value, and the initial power demand value of the peak power demand interval is a peak power demand value. At step 230, a target demand limit is calculated for the selected intervals based at least in part on the initial power demand values of the selected intervals. The target demand limit is less than the peak power demand value. At step 240, the target demand limit is applied to the power demand information to obtain a modified power demand profile in which at least the peak power demand value is reduced.

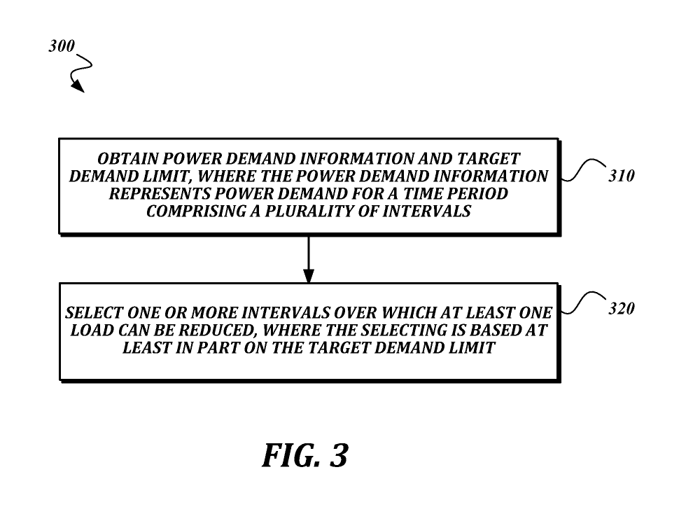

Selection of intervals can be performed automatically by a computer system, given a target demand limit that may be selected by a user or by the computer system. In the example shown in FIG. 3, at step 310 power demand information and a target demand limit are obtained by the computer system for a time period comprising a plurality of intervals. At step 320, the computer system selects one or more of the intervals over which at least one of the loads can be reduced. The selection of the intervals is based at least in part on the target demand limit.

In some embodiments, power loads may include a constrained power load that is subject to a constraint on the load. The constraint may include, for example, a minimum load value for a particular power load. The constraint may affect what the target demand limit can be for an interval that includes the constrained power load. For example, if a minimum load value is in effect for a particular set of intervals, the target demand limit may be greater than or equal to the minimum load value. The constraint may be set by a customer. For example, if a lighting system is required to be always on, a customer may specify that the power load associated with the lighting system must not be reduced. Such constraints may be included in load constraint information associated with power loads. To assist in identifying loads that may be reduced, the load constraint information may include an indication that one or more power loads can be reduced to meet the target demand limit for the selected intervals. These other power loads may still be constrained by a minimum load value, but the minimum load value may be lower than the target demand limit to allow some flexibility in reducing the load to some extent without falling below the minimum load value.

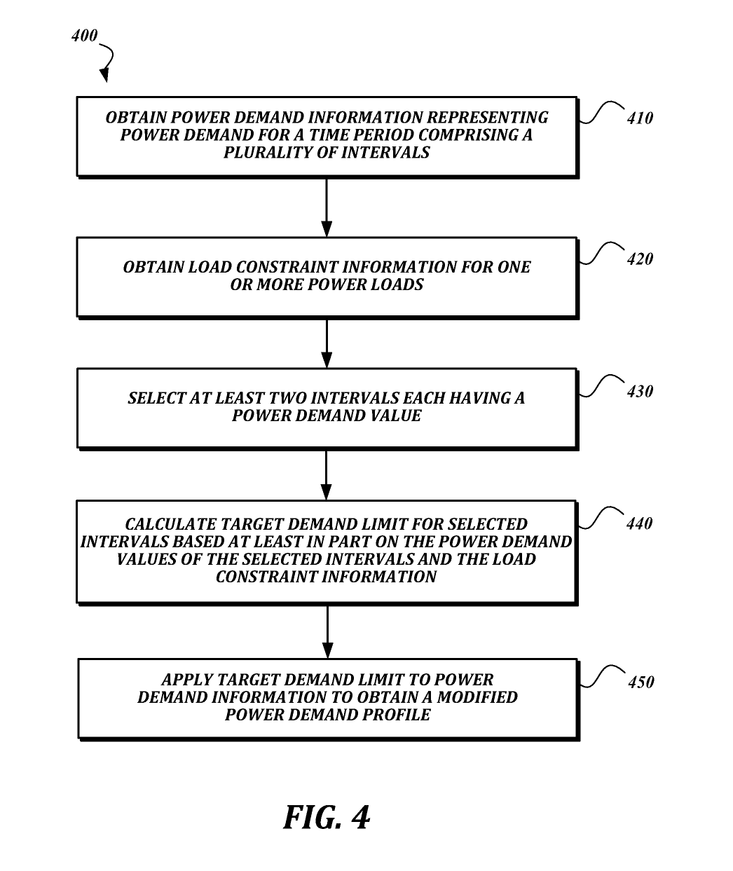

In the example shown in FIG. 4, power demand information is obtained at step 410, and load constraint information (e.g., a minimum load value) is obtained for one or more power loads at step 420. At step 430, at least two of the intervals are selected, and each of the selected intervals has a power demand value. At step 440, a target demand limit is calculated for the selected intervals based at least in part on the power demand values of the selected intervals and the load constraint information. At step 450, the target demand limit is applied to the power demand information to obtain a modified power demand profile.

In some embodiments, applying a target demand limit to power demand information may include comparing the target demand limit with power demand values of selected intervals and/or shifting power demand associated with at least one selected interval to one or more other intervals. For example, applying the target demand limit to the power demand information may include comparing the target demand limit with the power demand values of the respective selected intervals; identifying an overage in at least one of the selected intervals (e.g., a peak power demand interval) based on the comparison; and shifting the overage to at least one other of the selected intervals.

In some embodiments, intervals may have associated time-of-use parameters, such as on-peak, off-peak, or part-peak, and analysis can be performed for the different times-of-use, as explained in further detail below.

### DETAILED EXAMPLES

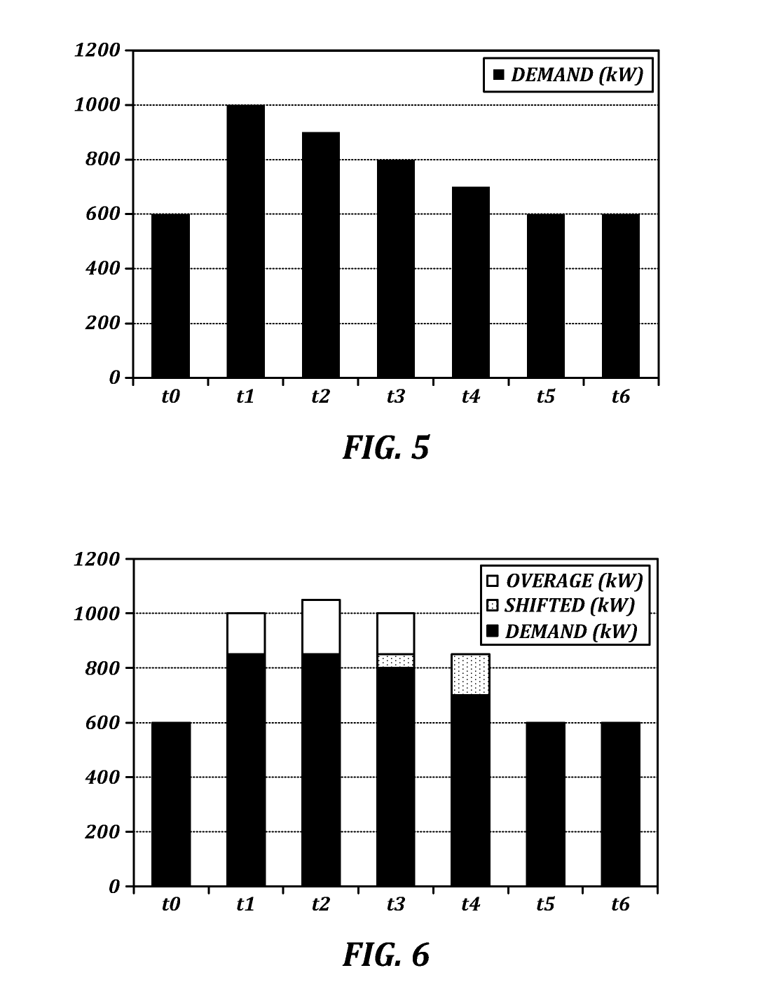

The following examples provide illustrative descriptions of principles described herein, with reference to FIGS. 5-8. It should be understood that the details provided in this example are non-limiting and may vary in accordance with the principles described herein.

Consider a user that is a customer of a utility that has a single time-of-use and bills customers at a rate of $10 for the peak demand for any debit interval within the billing period. FIG. 5 is a bar graph illustrating an example power demand profile for a billing period. According to the illustrative demand profile shown in FIG. 5, the peak demand for the month (1,000 kW) occurred in the interval at t1 and the demand charge would have been $10,000 for that month.

FIG. 6 is a bar graph illustrating a modified power demand profile for the billing period shown in FIG. 5. The graph in FIG. 6 shows the results of applying a target demand limit of 850 kW to the historical data shown in FIG. 5 in which it has been determined (e.g., by a user) that a window of 4 consecutive intervals should be analyzed to determine how loads that exceed the target demand limit can be shifted.

As shown in FIG. 6, at interval t1, 150 kW of the demand exceeds the recommended limit of 850 kW and is shifted to later intervals. At interval t2, an additional 50 kW is added to the overage shifted from interval t1, for a total overage of 200 kW to be shifted to later intervals. 50 kW of the overage can be shifted to interval t3, leaving 150 kW of overage to be shifted to interval t4, with no overage remaining. The peak demand for the billing period as modified in FIG. 6 is 850 kW, which is in line with the target demand limit and results in a demand charge of $8,500 and a savings of $1,500 relative to the demand profile shown in FIG. 5.

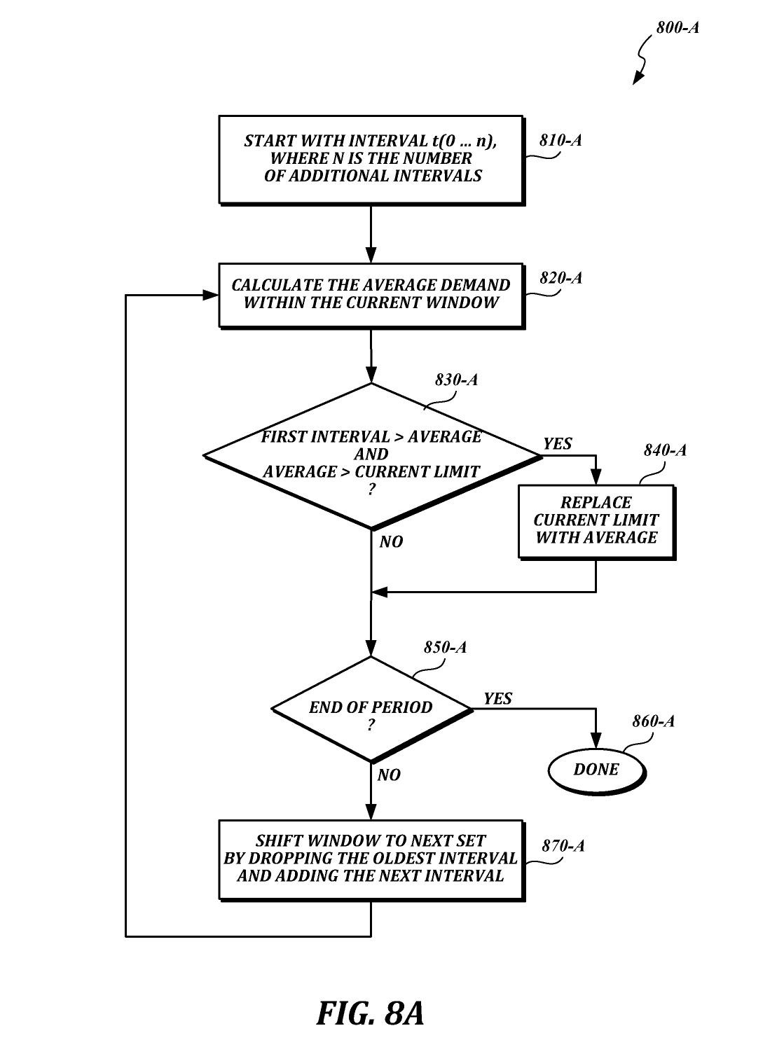

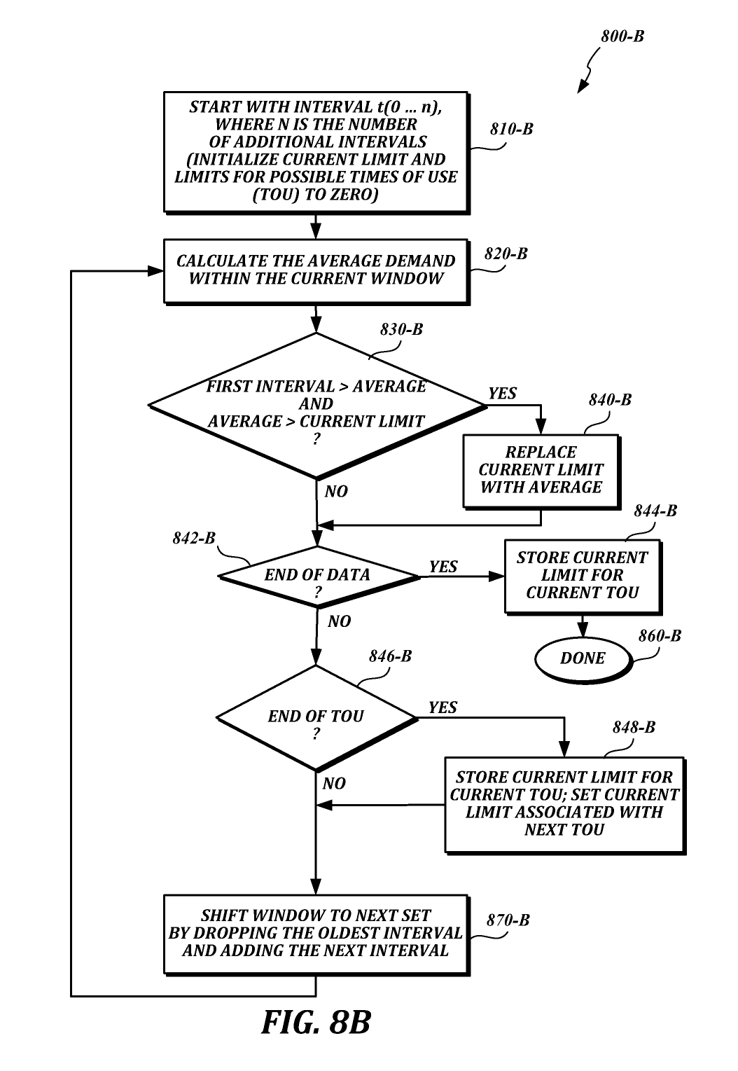

FIG. 8A is a flow chart of an illustrative process 800-A that can be used to determine the target demand limit applied in FIG. 6. At step 810-A, the process starts with a window of intervals t0-tn, where n is a number of additional intervals. In the example described with reference to FIGS. 5 and 6, the number of additional intervals is 3, for a total of 4 intervals in the window, and the initial window is t043. At step 820-A, an average demand is calculated for the window (e.g., 825 kW for the initial window t043).

At step 830-A, a check is performed to determine if the demand value for the first interval exceeds the average for the window and the average exceeds the current target demand limit for the interval. (In this example, the current target demand limit is initialized at 0 kW for ease of illustration, although other initial values can be used.) If both of these conditions are true, the process 800-A proceeds to step 840-A to replace the current target demand limit with the average for the window, and then to step 850-A to determine if the end of the period has been reached. If one or both of the conditions in step 830-A is not true, the process 800-A proceeds directly to step 850-A.

In the example described with reference to FIGS. 5 and 6, the first interval for the initial window t0-t3 has a demand value of 600 kW, which is less than the average of 825 kW. This means that the first condition of step 830 is not met, and the process proceeds to step 850-A.

At step 850-A, if the end of the period has been reached, the process ends at step 860-A. Otherwise, the process proceeds to step 870-A where the window is shifted by one interval, dropping the oldest interval and adding the next interval, before returning to step 820-A to process the shifted window.

In the example described with reference to FIGS. 5 and 6, the initial window t0-t3 does not coincide with the end of the period, so the shifted window t1-t4 is processed at step 820-A. The average demand within the shifted window t1-t4 is 850 kW. The first interval of the shifted window, t1, has a demand value of 1,000 kW, which is greater than the average of the shifted window. Because the average is also greater than the current target demand limit of 0 kW, the current limit is updated to be the average of 850 kW for the shifted window. As will be understood from the foregoing description, the target demand limit of 850 kW remains unchanged as the process 800-A continues for additional shifted windows up to the end of the period.

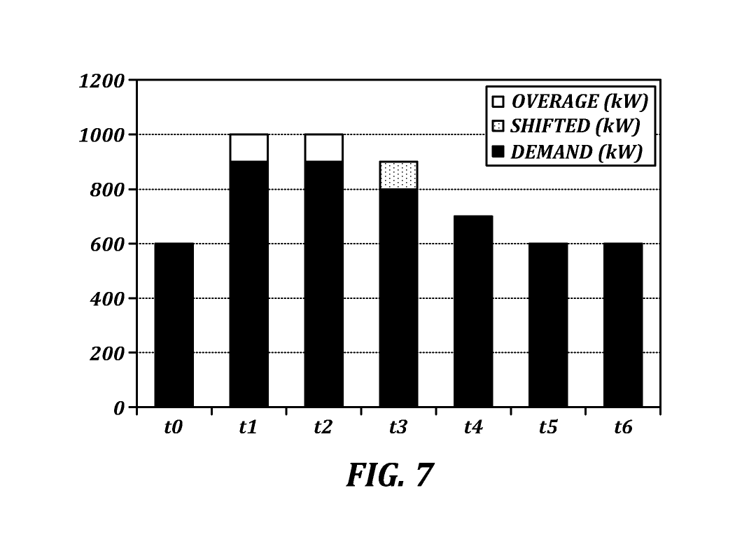

The illustrative shifting of demand that is described with reference to FIGS. 5 and 6 assumes that no constraints have been placed on the loads that make up the demand for the respective intervals. Some potential effects of limiting the reduction of loads are now described with reference to FIG. 7. In this example, assume that the user's facility has two loads (heating and lighting) which contribute to the overall demand, with maximum loads of 800 kW for heating and 200 kW for lighting. The user determines that half the lights in the facility could be turned off at any time to conserve energy, but the user also decides that they never want to turn down the heat.

FIG. 7 is a bar graph illustrating a modified power demand profile for the billing period shown in FIG. 5 in view of the constraints on the loads described above. Interval t1 represents an interval where the heating and lighting loads are at their maximum level (800 kW+200 kW=1,000 kW). Because the user has determined that lighting load can be reduced by half but the heating load should never be reduced, the minimum demand for interval t1 is 900 kW. This constrained demand limit can be set as the target demand limit. As shown in FIG. 7, at interval t1 the historical demand exceeds the constrained demand limit, and an overage of 100 kW is shifted to a later interval. With a historical demand value of 900 kW, interval t2 cannot accommodate the overage from interval t1 but also has no overage of its own. The 100 kW overage can be shifted to interval t3, with no overage remaining. The peak demand for the billing period as modified in FIG. 7 is 900 kW, which is in line with the target demand limit and results in a demand charge of $9,000 and a savings of $1,000 relative to the demand profile shown in FIG. 5.

If a constrained demand limit is present, it need not always be set as the target demand limit. For example, if the user in the example above determined that the lighting load could be reduced to 0 kW, this may result in a constrained demand limit of 800 kW. However, if a target demand limit (e.g., 850 kW via the illustrative process 800-A in FIG. 8A) is otherwise calculated to be greater than the constrained demand limit, the greater demand limit of 850 kW can be used.

The shifting of the overages shown in FIGS. 6 and 7 is only illustrative. For example, although the overage for interval t1 in FIG. 6 is shown for ease of illustration as being successively moved to interval t2, with the cumulative overage then being moved to intervals t3 and t4, overages or portions of overages may in practice be targeted for a single move to a particular interval that can accommodate the overage.

FIG. 8B is a flow chart of an illustrative process 800-B that can be used to determine a target demand limit in which multiple times-of-use (TOUs) may be in effect. In comparison to the illustrative process 800-A shown in FIG. 8A, the process 800-B tracks intermediate results for each TOU. At step 810-B, the process starts with a window of intervals t0-tn, where n is a number of additional intervals. The current limit and limits for the possible TOUs are initialized to zero. At step 820-B, an average demand is calculated for the window. At step 830-B, a check is performed to determine if the demand value for the first interval exceeds the average for the window and the average exceeds the current target demand limit for the interval. If both of these conditions are true, the process 800-B proceeds to step 840-B to replace the current target demand limit with the average for the window, and then to step 842-B to determine if the end of the data being processed has been reached. If one or both of the conditions in step 830-B is not true, the process 800-B proceeds directly to step 842-B.

At step 842-B, if the end of the data has been reached, the current limit is stored for the current TOU at step 844-B, and the process ends at step 860-B. Otherwise, the process proceeds to step 846-B. At step 846-B, if the end of the TOU has been reached, the current limit is stored for the current TOU and the current limit is set for the next TOU at step 848-B, and the process proceeds to step 870-B. Otherwise, the process proceeds directly to step 870-B.

At step 870-B, the window is shifted by one interval, dropping the oldest interval and adding the next interval, before returning to step 820-B to process the shifted window.

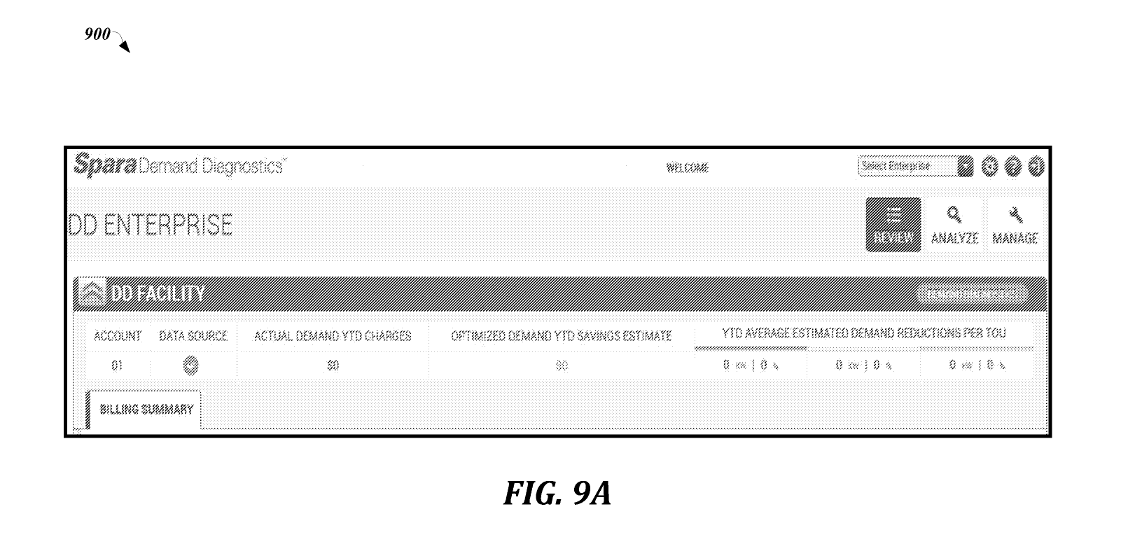

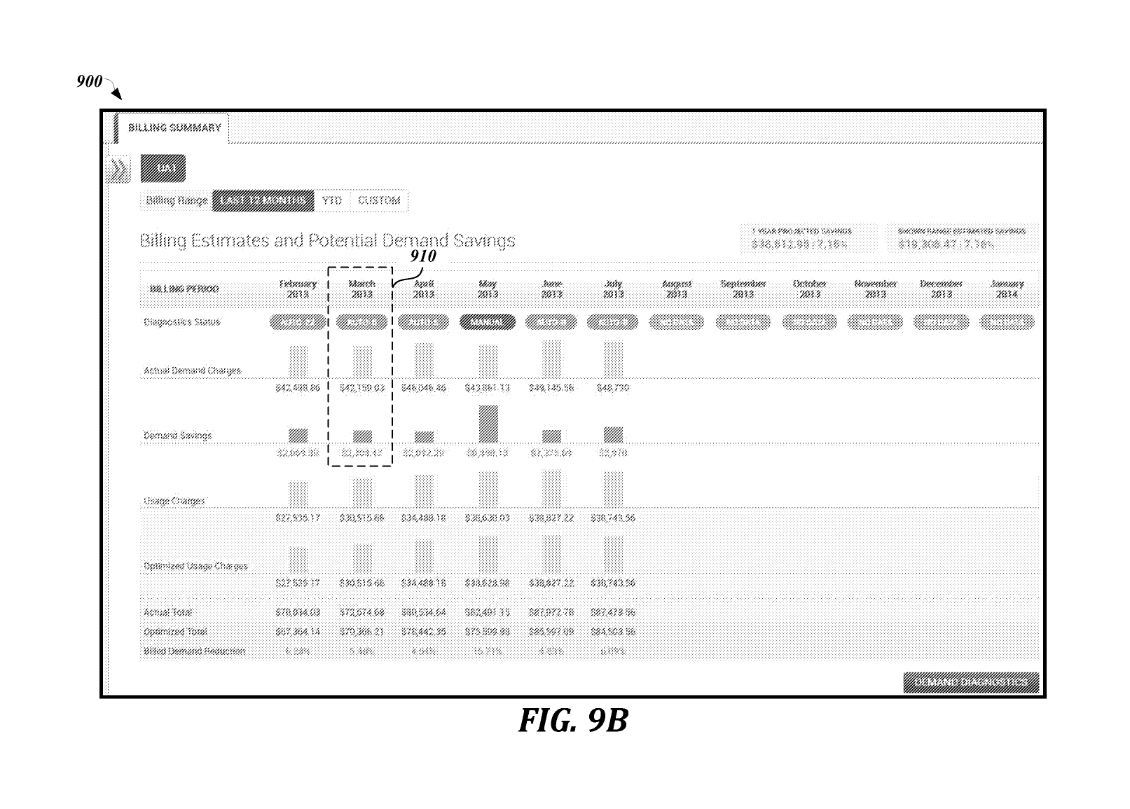

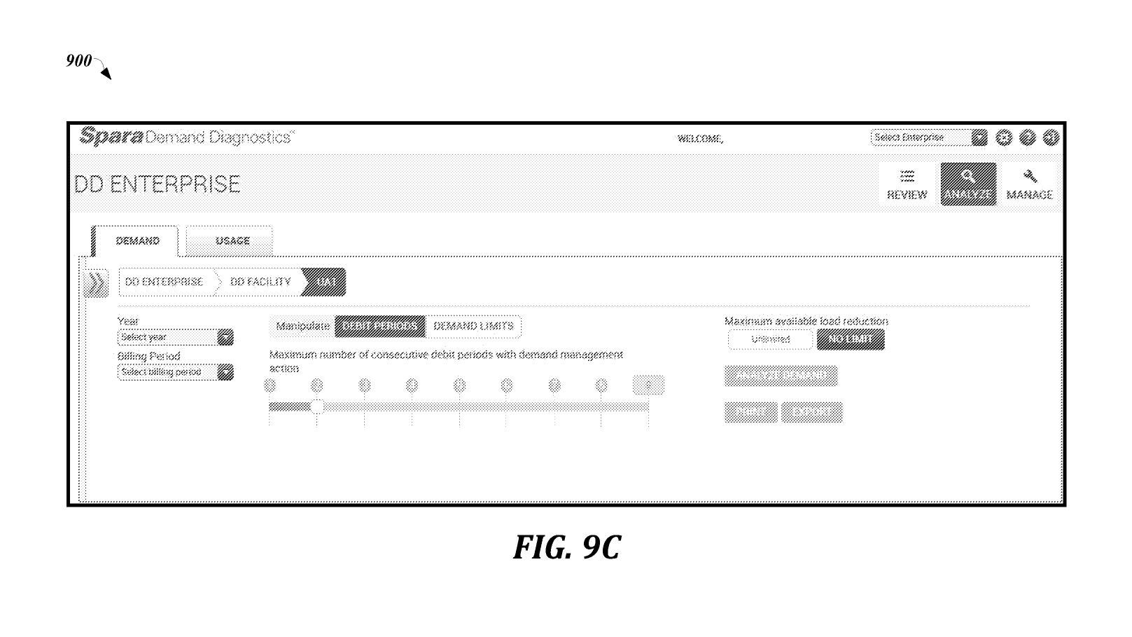

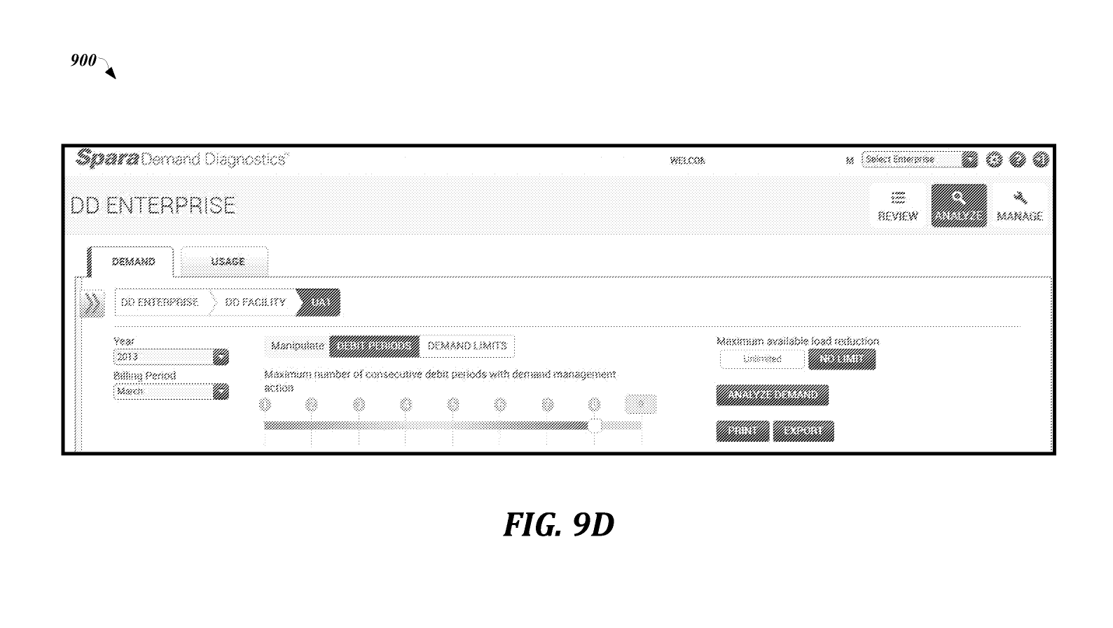

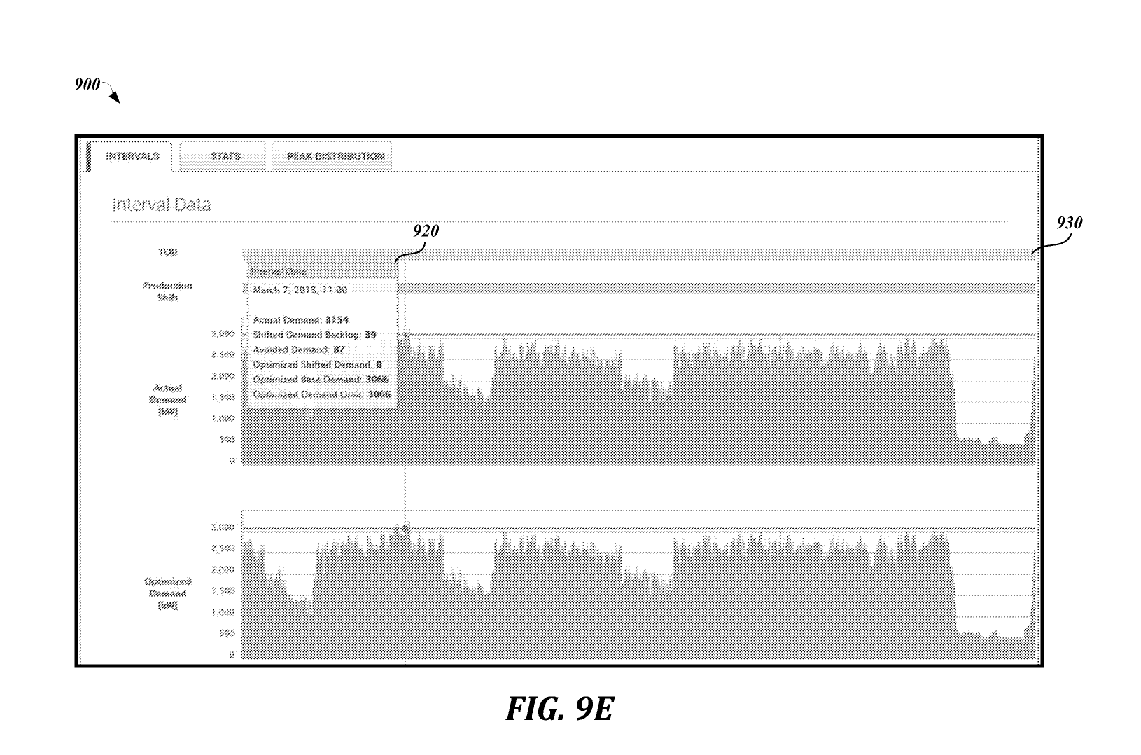

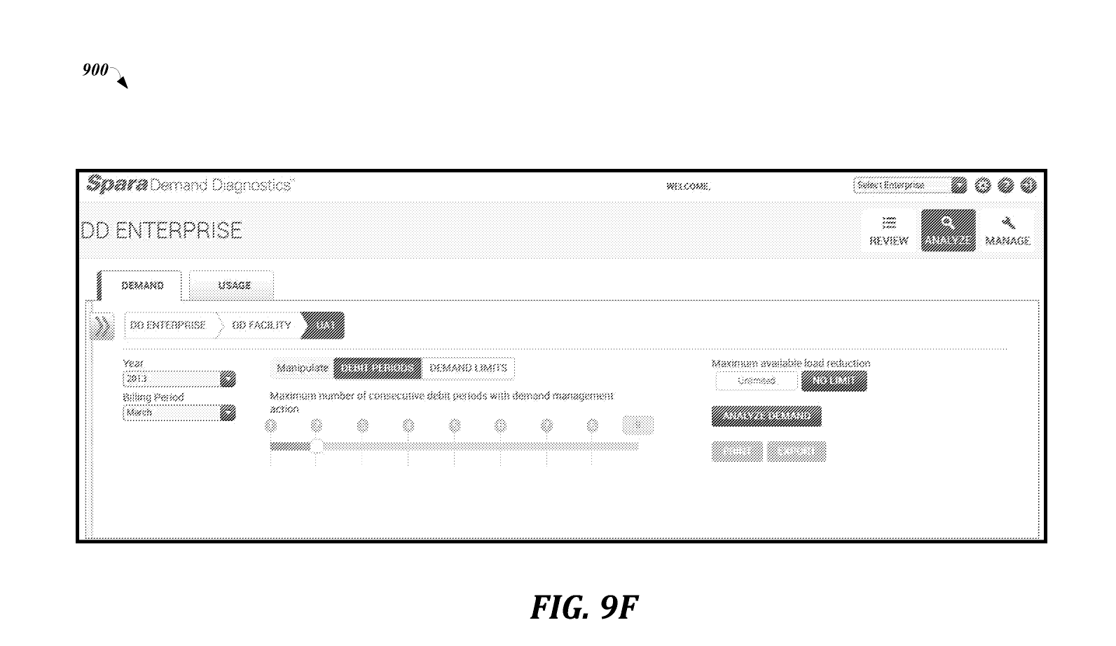

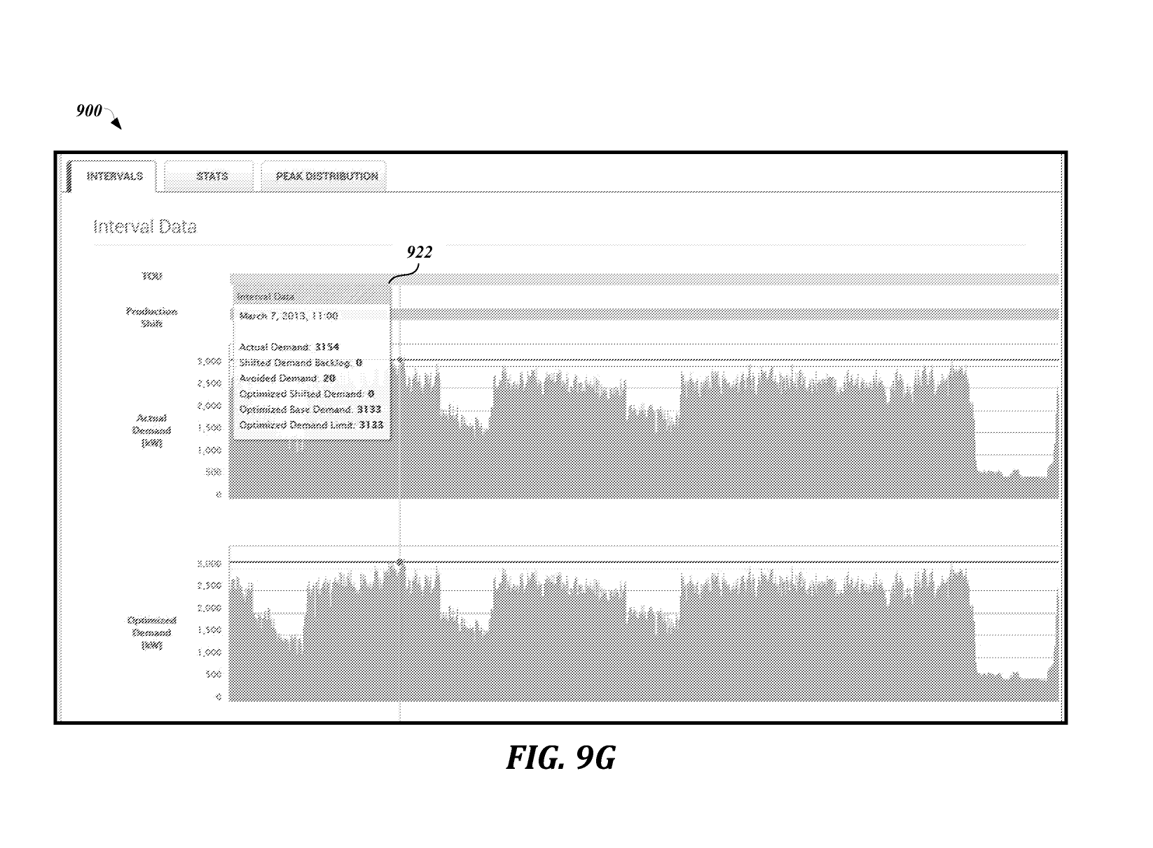

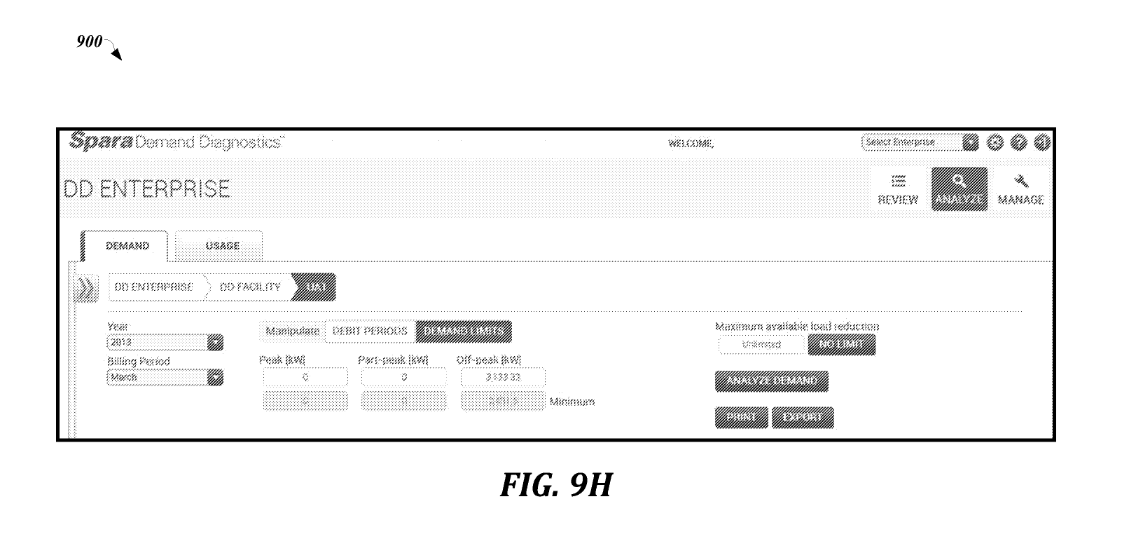

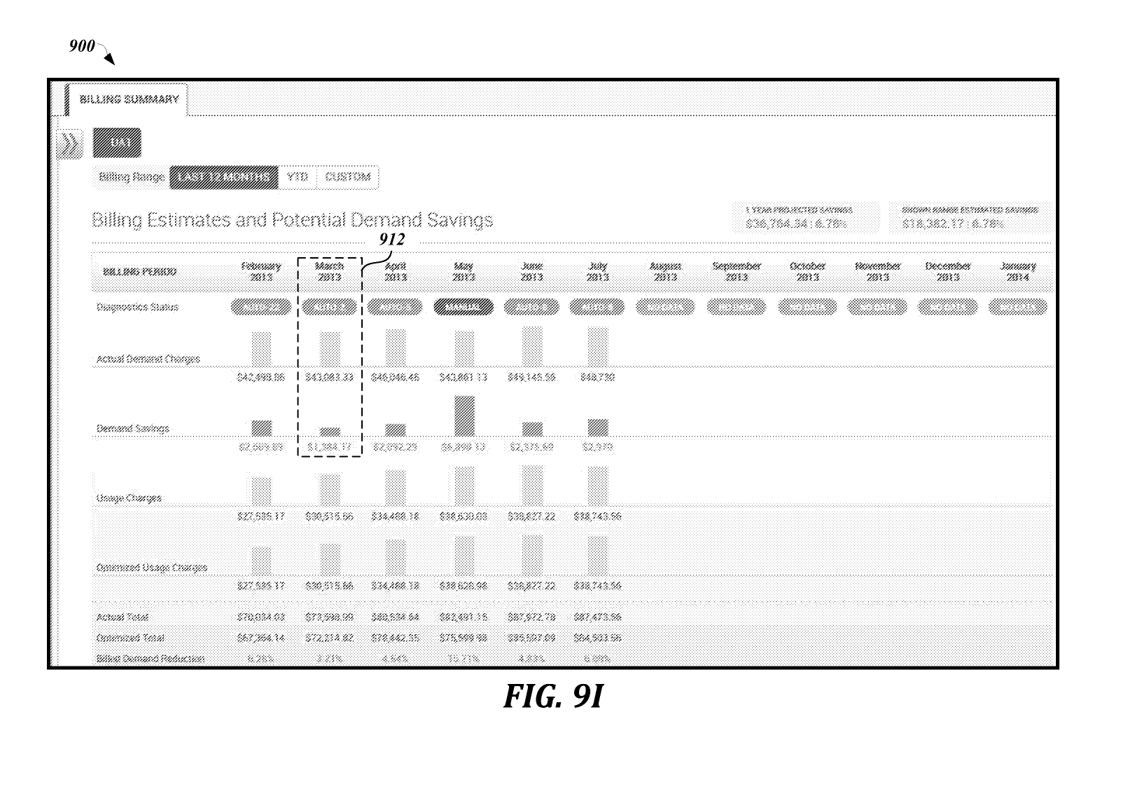

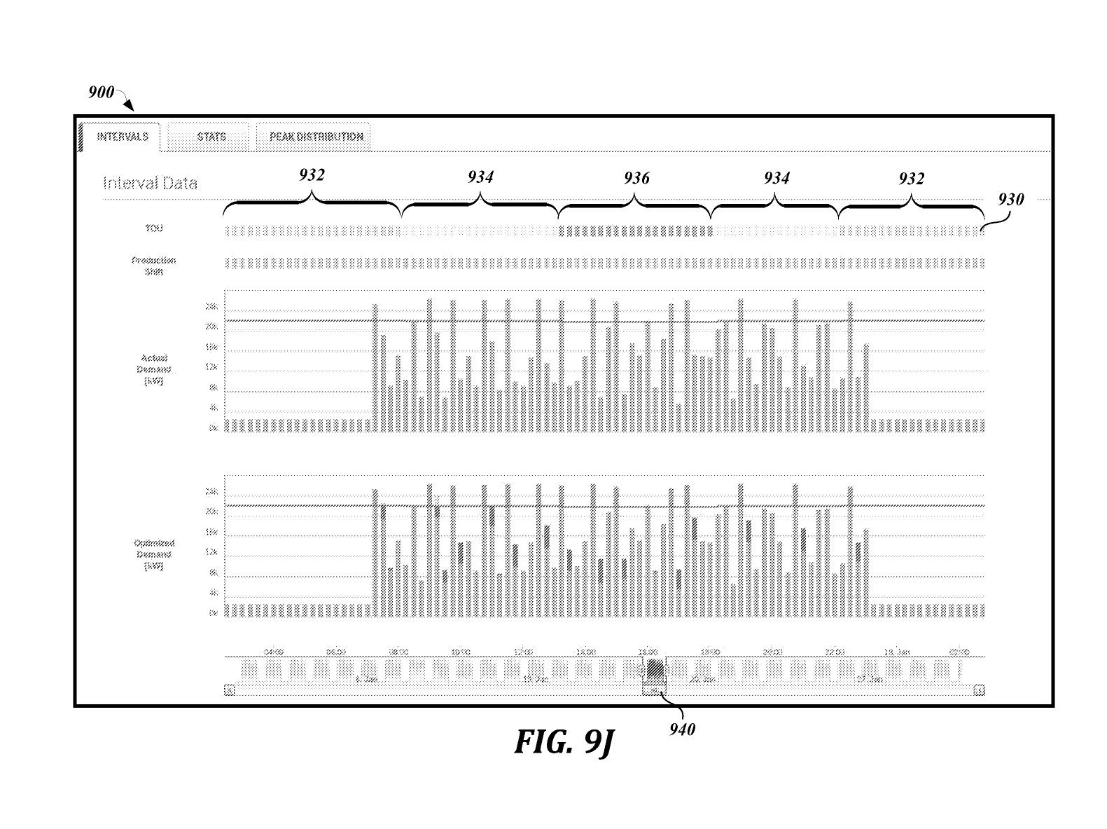

FIGS. 9A-9J illustrate features of an illustrative user interface 900 of a system for analyzing opportunities for power demand control that may be presented to a user. The user interface 900 may be provided by a server and presented to a user operating a user device (e.g., in a cloud computing environment, such as an arrangement in which historical power profiles are stored and processed on a server and accessed remotely by the user), or in some other way. The illustrated user interface is depicted as it may appear in a web browser. Alternatively, a user interface with similar functionality may be presented as a dedicated application on a desktop computer or a mobile device, such as a smart phone or tablet computer, or in some other form.

The user interface 900 is illustrative only, and not limiting. The user interface elements shown in FIGS. 9A-9J may be supplemented or replaced by any number of other elements exhibiting the same functionality and/or different functionality. In any of the described examples, user interface elements can be actuated by a keystroke, mouse click, voice activation, touchscreen input, or any other suitable user input event.

In the example shown in FIG. 9A, an illustrative start page showing a Billing Summary tab is shown. When the Billing Summary tab is activated, the user interface 900 can provide billing information, such as the Billing Summary and Potential Demand Savings table shown in FIG. 9B. This table includes information such as Diagnostics Status (e.g., a number of intervals selected for possible demand shifting), Actual Demand Charges, Demand Savings, Usage Charges, Optimized Usage Charges, Actual Total, Optimized Total, and Billed Demand Reduction for months of the year where the appropriate data is available. Dashed rectangle 910 indicates an example of some relevant information for a timeframe (e.g., March 2013) that can be changed in response to user input, as described in further detail below.

FIG. 9C depicts an analysis page that can be accessed from the start page, such as by activating the button labeled “Analysis” shown in FIGS. 9A and 9C, or the button labeled “Demand Diagnostics” in FIG. 9B. In FIG. 9C, the user is presented with options for demand analysis via user interface elements, including drop down boxes for selecting a time period (e.g., “Year” and “Billing Period”), a slider for selecting a maximum number of consecutive debit periods on which demand management action (e.g., shifting of power demand overages) can be performed, a text box for entering a maximum available load reduction, and a button for initiating demand analysis (labeled “Analyze Demand”) under the chosen parameters.

FIG. 9D depicts the analysis page of FIG. 9C after the March 2013 billing period has been selected. As shown, the maximum number of consecutive debit periods is set to 8. When the Analyze Demand button is activated, resulting data is presented. An example presentation of resulting data is shown in FIG. 9E.

In the example shown in FIG. 9E, “Interval Data” is depicted on a tab labeled “Intervals.” The Interval Data includes information such as an element depicting time-of-use (“TOU”) information, Production Shift information, an Actual Demand graph, and an Optimized Demand graph. The interval information box 920 provides detailed interval data associated with an interval of interest, and may appear in response to an event such as a mouse-over event. The interval information box 920 includes time and date of the interval along with data such as Actual Demand, Shifted Demand Backlog, Avoided Demand, Optimized Shifted Demand, Optimized Base Demand, and Optimized Demand Limit. In this example, the Optimized Demand Limit is an example of a target demand limit described herein. As shown, the Optimized Demand Limit is less than the Actual Demand for the interval, which may lead to cost savings. The Avoided Demand is estimated to be 87 kW, which is approximately equal to the difference between the Actual Demand (3,154 kW) and the Optimized Demand Limit (3,066 kW). Alternatively, the Avoided Demand could be the actual difference between these two values (e.g., 88 kW).

In the example shown in FIG. 9F, the user has moved the slider to reduce the maximum number of consecutive debit periods to 2. In the example shown in FIG. 9G, “Interval Data” is depicted with adjustments responsive to the lower maximum number of consecutive debit periods. The interval information box 922 shown in FIG. 9G is similar to the interval information box 920 shown in FIG. 9E, except that some of the corresponding values have changed. For example, the Optimized Demand Limit is now higher than the corresponding value shown in FIG. 9E, at 3,133 kW, and the corresponding Avoided Demand value is now lower than the corresponding value shown in FIG. 9E, at 20 kW.

In the example shown in FIG. 9H, boxes for entering demand limits for different time-of-use categories (e.g., Peak, Part-Peak, and Off-Peak) are shown, with the Optimized Demand Limit of 3,133 kW depicted in the Off-Peak box. In the example shown in FIG. 9I, an updated Billing Summary tab includes updated Demand Savings for March 2013, as shown in dashed rectangle 912. As shown, the projected Demand Savings are now lower, at $1,384.17, than the corresponding value ($2,308.47) in FIG. 9B. The Diagnostics Status in dashed rectangle 912 also has been updated to “Auto-2” (reflecting the choice of 2 consecutive intervals) from “Auto-8” in the corresponding portion of FIG. 9B.

In the example shown in FIG. 9J, interval data is shown for a 24-hour period. The different colors in the time-of-use (“TOU”) bar 930 show that different time-of-use parameters apply to different time periods 932, 934, 936, with an off-peak time period 932 from approximately 10 p.m.-8 a.m, part-peak time periods 934 from approximately 8 a.m.-1 p.m. and 6-10 p.m., and an on-peak time period 936 from approximately 1-6 p.m. A zoom indicator 940 shows the period within a longer timeline (e.g., the month of January) that corresponds to the displayed interval data. The zoom level can be adjusted, as desired, to show interval data at different levels of detail.

### Operating Environment

Unless otherwise specified in the context of specific examples, described techniques and tools may be implemented by any suitable computing devices, including, but not limited to, laptop computers, desktop computers, smart phones, tablet computers, and/or the like.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client is receiving information provided by a server at a remote location.

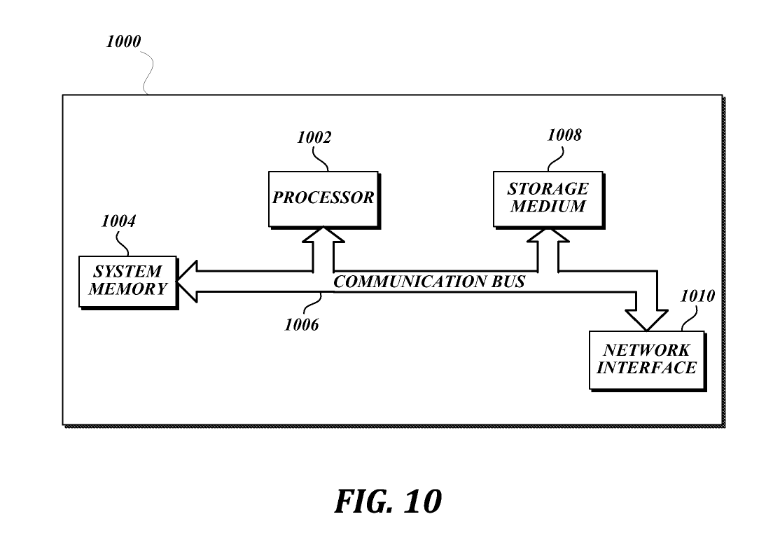

FIG. 10 is a block diagram that illustrates aspects of an illustrative computing device 1000 appropriate for use in accordance with embodiments of the present disclosure. The description below is applicable to servers, personal computers, mobile phones, smart phones, tablet computers, embedded computing devices, and other currently available or yet-to-be-developed devices that may be used in accordance with embodiments of the present disclosure.

In its most basic configuration, the computing device 1000 includes at least one processor 1002 and a system memory 1004 connected by a communication bus 1006. Depending on the exact configuration and type of device, the system memory 1004 may be volatile or nonvolatile memory, such as read only memory (“ROM”), random access memory (“RAM”), EEPROM, flash memory, or other memory technology. Those of ordinary skill in the art and others will recognize that system memory 1004 typically stores data and/or program modules that are immediately accessible to and/or currently being operated on by the processor 1002. In this regard, the processor 1002 may serve as a computational center of the computing device 1000 by supporting the execution of instructions.

As further illustrated in FIG. 10, the computing device 1000 may include a network interface 1010 comprising one or more components for communicating with other devices over a network. Embodiments of the present disclosure may access basic services that utilize the network interface 1010 to perform communications using common network protocols. The network interface 1010 may also include a wireless network interface configured to communicate via one or more wireless communication protocols, such as WiFi, 2G, 3G, 4G, LTE, WiMAX, Bluetooth, and/or the like.

In the illustrative embodiment depicted in FIG. 10, the computing device 1000 also includes a storage medium 1008. However, services may be accessed using a computing device that does not include means for persisting data to a local storage medium. Therefore, the storage medium 1008 depicted in FIG. 10 is optional. In any event, the storage medium 1008 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like.

As used herein, the term “computer-readable medium” includes volatile and nonvolatile and removable and nonremovable media implemented in any method or technology capable of storing information, such as computer-readable instructions, data structures, program modules, or other data. In this regard, the system memory 1004 and storage medium 1008 depicted in FIG. 10 are examples of computer-readable media.

For ease of illustration and because it is not important for an understanding of the claimed subject matter, FIG. 10 does not show some of the typical components of many computing devices. In this regard, the computing device 1000 may include input devices, such as a keyboard, keypad, mouse, trackball, microphone, video camera, touchpad, touchscreen, electronic pen, stylus, and/or the like. Such input devices may be coupled to the computing device 1000 by wired or wireless connections including RF, infrared, serial, parallel, Bluetooth, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 1000 (e.g., a client device), or can be integral components of the computing device 1000. In some embodiments, multiple input devices may be combined into a single, multifunction input device (e.g., a video camera with an integrated microphone). Any suitable input device either currently known or developed in the future may be used with systems described herein.

The computing device 1000 may also include output devices such as a display, speakers, printer, etc. The output devices may include video output devices such as a display or touchscreen. The output devices also may include audio output devices such as external speakers or earphones. The output devices can be separate from and communicatively coupled to the computing device 1000, or can be integral components of the computing device 1000. In some embodiments, multiple output devices may be combined into a single device (e.g., a display with built-in speakers). Further, some devices (e.g., touchscreens) may include both input and output functionality integrated into the same input/output device. Any suitable output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

### EXTENSIONS AND ALTERNATIVES

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

The embodiments of the invention in which an exclusive property or privilege is claimed are defined as follows:

1. A computer-implemented method comprising:
obtaining power demand information for a time period comprising a plurality of intervals, wherein the power demand information represents power demand for the time period, and wherein the power demand includes one or more power loads;
selecting at least two of the plurality of intervals, wherein each of the selected intervals has a power demand value;
calculating a target demand limit for the selected intervals based at least in part on the power demand values of the selected intervals; and
applying the target demand limit to the power demand information to obtain a modified power demand profile.

2. The method of claim 1, wherein applying the target demand limit to the power demand information comprises comparing the target demand limit with the power demand values of the selected intervals.

3. The method of claim 1, wherein applying the target demand limit to the power demand information comprises shifting power demand associated with at least one of the selected intervals to at least one other of the selected intervals.

4. The method of claim 1, wherein applying the target demand limit to the power demand information comprises:
comparing the target demand limit with the power demand values of the selected intervals;
identifying an overage in at least one of the selected intervals based on the comparing; and
shifting the overage to at least one other of the selected intervals.

5. The method of claim 1, wherein calculating the target demand limit comprises calculating an average of the power demand values of the selected intervals.

6. The method of claim 1, wherein the power demand values of the selected intervals comprise a peak power demand value for the time period, and wherein the target demand limit is less than the peak power demand value.

7. The method of claim 1, wherein the target demand limit facilitates controlling the one or more power loads for the selected intervals.

8. The method of claim 7, wherein controlling the one or more power loads for the selected intervals comprises reducing at least one of the one or more power loads for at least one of the selected intervals.

9. The method of claim 7, wherein the one or more power loads comprise at least two power loads, and wherein controlling the one or more power loads for the selected intervals comprises, for at least one of the selected intervals, maintaining at least one of the power loads and reducing at least one of the power loads.

10. The method of claim 1, wherein the time period is a billing period.

11. The method of claim 1, wherein the selected intervals are consecutive intervals.

12. The method of claim 1, wherein at least one of the selected intervals has a time-of-use parameter selected from the group consisting of: on-peak, off-peak, and part-peak.

13. The method of claim 1, wherein the power demand information comprises a historical power demand profile.

14. The method of claim 1, wherein the selected intervals are selected by a user.

15. The method of claim 1, wherein the selected intervals are selected automatically.

16. A computer-implemented method comprising:
obtaining power demand information for a time period comprising a plurality of intervals, wherein the power demand information represents power demand for the time period, and wherein the power demand includes one or more power loads;
selecting at least two intervals of the plurality of intervals, wherein each of the selected intervals has an initial power demand value, wherein the selected intervals comprise a peak power demand interval, and wherein the initial power demand value of the peak power demand interval is a peak power demand value;
calculating a target demand limit for the selected intervals based at least in part on the initial power demand values of the selected intervals, wherein the target demand limit is less than the peak power demand value; and
applying the target demand limit to the power demand information to obtain a modified power demand profile in which at least the peak power demand value is reduced.

17. The method of claim 16, wherein the target demand limit facilitates controlling the one or more power loads for the selected intervals, and wherein controlling the one or more power loads for the selected intervals comprises reducing at least one of the one or more power loads for at least the peak power demand interval.

18. A computer-implemented method comprising:
obtaining power demand information for a time period comprising a plurality of intervals, wherein the power demand information represents power demand for the time period, and wherein the power demand includes one or more power loads;
obtaining load constraint information for the one or more power loads;
selecting at least two of the plurality of intervals, wherein each of the selected intervals has a power demand value;
calculating a target demand limit for the selected intervals based at least in part on the power demand values of the selected intervals and the load constraint information; and
applying the target demand limit to the power demand information to obtain a modified power demand profile.

19. The method of claim 18, wherein the load constraint information comprises a minimum load value for at least one of the one or more power loads.

20. The method of claim 18, wherein the load constraint information comprises an indication that at least one of the one or more power loads can be reduced to meet the target demand limit for the selected intervals.

21. A computer-implemented method comprising:
by a computer system, obtaining power demand information and a target demand limit for a time period comprising a plurality of intervals, wherein the power demand information represents power demand for the time period, and wherein the power demand includes one or more power loads; and
by the computer system, selecting one or more of the intervals over which at least one of the one or more power loads can be reduced, wherein the selecting is based at least in part on the target demand limit.

22. The method of claim 21, wherein the target demand limit is calculated as an average of power demand values of the selected intervals.

23. The method of claim 21, wherein power demand values of the selected intervals comprise a peak power demand value for the time period, and wherein the target demand limit is less than the peak power demand value.

24. The method of claim 21, wherein the one or more power loads comprise a constrained power load.

25. The method of claim 21, wherein the target demand limit facilitates controlling the one or more power loads for the selected intervals.

26. The method of claim 25, wherein controlling the one or more power loads for the selected intervals comprises reducing at least one of the one or more power loads for at least one of the selected intervals.

27. The method of claim 25, wherein the one or more power loads comprise at least two power loads, and wherein controlling the one or more power loads for the selected intervals comprises, for at least one of the selected intervals, maintaining at least one of the power loads and reducing at least one of the power loads.

28. The method of claim 21, wherein the target demand limit is selected by a user.

29. The method of claim 21, wherein the target demand limit is calculated automatically by the computer system.
